(19) United States
(12) Patent Application Publication
(10) Pub. No.: US 2021/0008805 A1
(43) Pub. Date: Jan. 14, 2021

(54) ADDITIVE MANUFACTURING SYSTEM

(71) Applicant: HEWLETT-PACKARD DEVELOPMENT COMPANY, L.P., Spring, TX (US)

(72) Inventors: Pol Fornos Martinez, Sant Cugat del Valles (ES); Emilio Sapena Masip, Sant Cugat del Valles (ES); Manuel Freira Garcia, Sant Cugat del Valles (ES)

(21) Appl. No.: 16/605,578

(22) PCT Filed: Apr. 6, 2018
(86) PCT No.: PCT/US2018/026568

§ 371 Date: Oct. 16, 2019

(51) Int. Cl. B29C 64/393; B33Y 50/02

(52) U.S. Cl. CPC B29C 64/393; B33Y 10/00; B33Y 50/02

(57) ABSTRACT

A method and system for classifying a plurality of three-dimensional objects to be formed by an additive manufacturing system into a plurality of groups, each associated with a different respective value of an operation parameter associated with the additive manufacturing system. First and second portions of a build volume of the additive manufacturing system are assigned to first and second groups of the plurality of groups, respectively. With the additive manufacturing system configured with a first value of the operation parameter, the additive manufacturing system is used to form, within the first portion of the build volume, a first object of the first group. Subsequently, the additive manufacturing system is configured with a second value of the operation parameter and used to form, within the second portion of the build volume, a second object of the second group.

### BACKGROUND

Additive manufacturing systems, including those commonly referred to as “3D printers”, provide a convenient way to produce three-dimensional objects. These systems may receive a definition of a three-dimensional object in the form of an object model. This object model is processed to instruct the system to produce the object. This may be performed by depositing a series of layers of a build material in a working area of the system. Chemical agents, referred to as “printing agents”, may be selectively deposited onto each layer of the build material within the working area. In one case, the printing agents may include one or more of a fusing agent and a detailing agent, among others. Energy may be applied using a radiation source, such as an infrared lamp, to fuse areas of a layer where fusing agent has been deposited. The process may be repeated for further layers to build up a final object.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic block diagram of an additive manufacturing system according to examples;

FIG. 2 shows schematically an additive manufacturing system according to examples;

FIG. 3 is a flow diagram showing a method of operating an additive manufacturing system according to examples;

FIG. 4 is a flow diagram illustrating a classification procedure according to examples;

FIG. 5 is a flow diagram illustrating a printing procedure according to examples;

FIG. 6 shows schematically the formation of a first object and a second object according to examples;

FIG. 7 is a graph illustrating the energy configuration of an energy source of an additive manufacturing system and the temperature of a series of objects being manufactured by the additive manufacturing system according to examples;

FIG. 8 shows schematically the formation of a first, second, third and fourth object accordingly examples;

FIG. 9 is a schematic block diagram of a three-dimensional (3D) printing system according to examples;

FIG. 10 shows schematically a computer-readable storage medium according to examples; and

FIG. 11 is a flow diagram illustrating features of a method of operating an additive manufacturing system according to yet further examples.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In an example additive manufacturing system, sometimes referred to as a three-dimensional (3D) printing system or an additive manufacturing apparatus, build material is deposited in layers in a working area, which may be referred to as a build chamber or a build volume. Chemical agents, referred to herein as “printing agents”, are selectively deposited onto each layer within the build chamber. The printing agents may include, for example, a fusing agent and/or a detailing agent. The fusing agent may be selectively applied to a layer of the build material in areas where particles of the build material are to be fused together by subsequent application of energy, and the detailing agent may be selectively applied where the fusing action, or a temperature, is to be reduced or controlled. For example, a detailing agent may be applied to reduce fusing at an object boundary to produce a part with sharp and smooth edges. It is to be appreciated, though, that in some systems, such as high speed sintering (HSS) systems, a detailing agent may not be applied. Following the application of printing agents, energy, for example thermal energy, is applied to the layer from an energy source of the additive manufacturing system. This causes build material on which the fusing agent has been applied to heat up above the melting temperature of the build material and to melt, coalesce and solidify. The process is then repeated for another layer, such that objects are built from a series of cross-sections. In other cases, one or other of the fusing agent and the detailing agent may be applied. For example, in some cases, a fusing agent may be selectively applied to regions of a layer of build material which are to be fused. In another example, a detailing agent may be selectively applied to regions of a layer of build material that are not to be fused.

The quality of an object manufactured by an additive manufacturing system may depend on various operation parameters associated with the additive manufacturing system, such as the amount of energy supplied by the energy source of the additive manufacturing system during fusing of the build material. If the energy source does not supply enough energy, the object may suffer from visible strips or channels, giving the appearance of wrinkled skin, which may be referred to as “elephant skin”. Conversely, if the energy source supplies an excess of energy, a defect known as “thermal bleed” may occur, in which chunks of partially-melted build material are attached to an outer surface of the object.

To produce an object with a particular quality, a value of an operation parameter may be tuned, for example to increase or decrease the amount of energy supplied by the energy source, to reduce defects such as elephant skin or thermal bleed. Different objects may have different operational requirements. Different objects may therefore be printed using different values of the operation parameter.

In examples herein, a plurality of three-dimensional objects to be formed by an additive manufacturing system is classified into a plurality of groups. Each of the plurality of groups is associated with a different respective value of the operation parameter. A first portion of a build volume of the additive manufacturing system is assigned to a first group of the plurality of groups, A second portion of the build volume, different from the first portion of the build volume, is assigned to a second group of the plurality of groups and with a second value of the operation parameter. The additive manufacturing system is configured with a first value of the operation parameter, the first value of the operation parameter being the value associated with the first group. With the additive manufacturing system configured with the first value of the operation parameter, the additive manufacturing system is used to form, within the first portion of the build volume, a first object of the first group, the first object formed of a first plurality of layers of a build material. Subsequently, the additive manufacturing system is configured with a second value of the operation parameter, the second value of the operation parameter being the value associated with the second group. With the additive manufacturing system configured with the second value of the operation parameter, the additive manufacturing system is used to form, within the second portion of the build volume, a second object of the second group, the second object formed of a second plurality of layers of the build material, subsequent to the first plurality of layers.

In this way, a plurality of objects can be organized or otherwise arranged into appropriate groups so that objects to be printed with the same values of the operation parameter can be printed within the same portion of the build volume. This allows objects to be printed with different values of the operation parameter, such as different energy configurations of the energy source, within the same build process. Hence, objects with different properties (such as geometries, sizes, internal structures or mechanical properties), which may have different operational tolerances during printing, may be printed within a single print job. This may be more efficient than other approaches, such as printing objects with different properties in different respective print jobs. Furthermore, the manufactured objects may be of a higher quality than if the objects were formed without using different values of the operation parameter depending on a property of the object to be formed.

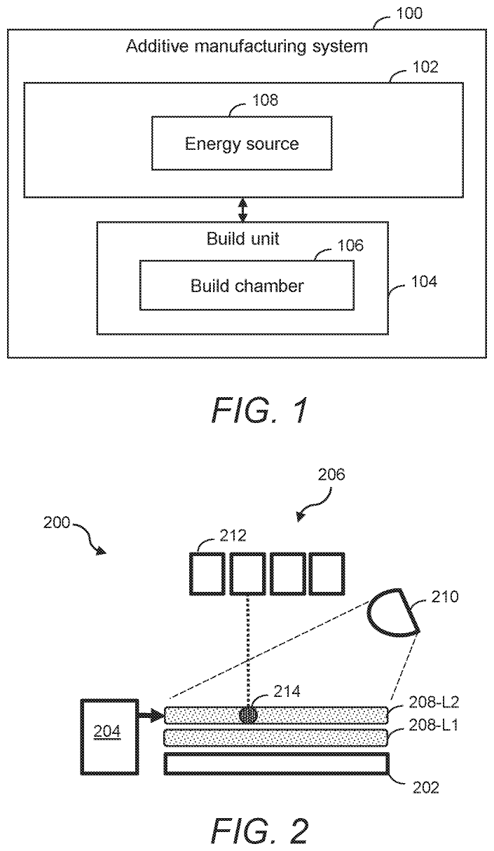

FIG. 1 shows a simplified schematic diagram of an additive manufacturing system 100 according to an example. The additive manufacturing system 100 in this example includes a 3D printer 102 coupled to a build unit 104.

According to an example, a 3D print operation includes depositing a layer of a build material onto a build platform of the build unit 104. The build platform may be considered to form part of a build chamber 106, which may be referred to as a build volume, build region or working area. In the example shown in FIG. 1, the build unit 104 is detachable from the 3D printer 102. In particular, the build unit 104 may be removed by an operator to perform a refill operation of the build unit 104. However, in other examples, the build unit 104 and the 3D printer 102 may be integral with each other.

The build unit 104 stores a supply of build material, for example, build powder. In one example a clean-up stage is performed on the build unit 104 prior to a build powder fill operation. For example, in one case a clean-up stage includes a powder management station removing unused build material from the build unit 104 and combining the unused build material with fresh build material for a further print operation. Unused build material may be recovered and recycled by a build powder management station, for instance, and mixed with virgin (or ‘new’) build material. Following a build powder fill operation, the operator may return the build unit 104 to the 3D printer 102 to perform further print operations.

The 3D printer 102 of FIG. 1 includes an energy source 108 to supply energy to build material as part of a fusing process in which the build material within the build chamber is selectively fused to form an object. This is shown in further detail in FIG. 2, which shows schematically an additive manufacturing system 200 according to examples. The additive manufacturing system 200 may be the same as or similar to the additive manufacturing system 100 of FIG. 1. Although the example of FIG. 2 is provided to understand the context of the examples described herein, those examples may be applied to a variety of additive manufacturing systems.

In FIG. 2, the additive manufacturing system 200 includes a build platform 202, a build material supply mechanism 204 and a solidifying system 206. A three-dimensional volume within which the build material is supplied may be considered to correspond to a build chamber (which may be referred to as a build volume). The build platform 202 may be lowered into the build chamber to allow each layer of build material to be deposited.

The build material supply mechanism 204 deposits a powdered build material on the build platform 202 in successive layers. Two layers are shown in FIG. 2: a first layer 208-L1 upon which a second layer 208-L2 has been formed by the build material supply mechanism 204. In certain cases, the build material supply mechanism 204 is arranged to move relative to the build platform 202 such that successive layers are formed on top of each other.

There are various different kinds of build materials from which a particular part or object may be built. The choice of build material may be made based on the desired properties of the part or object to be printed. In certain additive manufacturing systems; the build material may be changed between builds accordingly. For example, various plastic powder types can be used as the raw build material; for example, thermoplastics, such as polyamide (PA) 11, PA12, and thermoplastic polyurethane (TPU), etc. According to one example, a suitable build material may be PA12 build material commercially known as V1R10A “HP PA12” available from HP Inc. In other examples, ceramic or metal build materials, such as powders or powder-like materials, may be used. The build material may include short fiber build materials. For example, the powder may be formed from, or may include, short fibers that may, for example have been cut into short lengths from long strands or threads of material.

The additive manufacturing system 200 of FIG. 2 includes an energy source 210, which may be a radiation source or other source for supplying heat to the build chamber. For example, the energy source 210 may be a heating system, The energy source 210 may include a lamp, for example a short-wave incandescent or infra-red lamp. In other examples, the energy source 210 is another light source constructed to emit electromagnetic radiation across a range of wavelengths to heat the build material, For example, the energy source 210 may be a halogen lamp. In certain cases, the additive manufacturing system 200 may include additional energy sources or radiation sources to heat the build material. In certain cases, energy sources may have other uses. For example, the additive manufacturing system 200 may include lighting systems to illuminate the working area.

In certain examples, an infra-red “pre-heat” lamp may be used to heat the build material, The pre-heat lamp may be located, for example, above the build platform 202, for example so that it heats at least an upper surface of the build material. The pre-heat lamp may be controlled to heat the build material to a temperature just below a melting point of the build material. Another energy source may then be used during construction of a 3D object. For example, in one implementation a separate fusing lamp may be used. The fusing lamp may apply energy to cause fusing of build material on which a fusing agent has been applied. Examples described herein relate to the configuration of an energy source to fuse build material, such as a fusing lamp.

The energy source 210 may be moveable relative to the build platform 202. For example, in one implementation a fusing lamp may be carriage-mounted to scan across build material that is formed on the build platform 202, In some examples, a layer of build material may therefore be pre-heated by a static infra-red lamp and selectively fused with a scanning fusing lamp (although in other cases, the layer of the build material may be selectively fused by the fusing lamp without first being pre-heated). For example, a scanning fusing lamp may be controlled to scan the deposited build material and thereby substantially uniformly apply heat to the deposited build material. As explained in more detail below, heat absorption is highest in areas where a fusing agent has been deposited. In other examples, a pre-heat lamp may be moveable in relation to the build platform 202; in this case the pre-heat lamp may be selectively applied to areas of the upper surface of the build material so as to heat these areas. In certain cases, a pre-heat lamp may not be used, and a fusing lamp is used as the energy source to both pre-heat the build material and to cause selective fusing. Temperature stabilization of the build material layers may be achieved using at least one preheat lamp and/or using at least one fusing lamp.

In certain examples, including the example of FIG. 2, the solidifying system 206 includes a printing agent deposit mechanism 212. The printing agent deposit mechanism 212 for example includes at least one print head to deposit a fusing agent and a detailing agent. The fusing agent increases heating of the build material when energy is applied to the build material on which the fusing agent has been deposited (compared to portions of the build material on which no fusing agent is applied). The detailing agent reduces heating of the build material. For example, the printing agent deposit mechanism 212 may include an inkjet deposit mechanism for printing a plurality of printing agents onto layers 208 of powdered build material. In this case, an inkjet print head may be adapted to deposit one (or multiple) printing agents onto layers of powdered polymer build material that form the build material. In certain cases, each print head within the inkjet deposit mechanism may be arranged to deposit a particular printing agent upon defined areas within a plurality of successive build material layers.

A fusing agent (sometimes also referred to as a “coalescing agent”) may increase heating of the build material by acting as an energy absorbing agent that causes build material on which it has been deposited to absorb more energy (e.g. from the energy source 210) than build material on which no fusing agent has been deposited. This may cause build material to heat up.

When constructing a 3D object, heat may be applied to the build material, for example from the energy source 210. As noted above, the fusing agent acts as an energy absorbing agent, and absorbs heat energy. Regions of build material to which the fusing agent is applied are thus heated to a greater degree than regions of build material to which the fusing agent is not applied. This heating may cause the regions of build material to which the fusing agent is applied to reach a temperature above the fusing temperature of the build material, and thereby fuse. In some examples, during a print operation for forming a 3D object, the build material may be maintained at a temperature slightly below the fusing temperature of the build material to reduce the amount of energy supplied by the energy source 210 and absorbed by the fusing agent to fuse the build material.

According to examples, a suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of inks comprising visible light enhancers are dye based colored ink and pigment based colored ink, such as inks commercially known as CE039A and CE042A available from HP Inc.

A detailing agent (sometimes also referred to as a “modifying agent”) may act to modify the effect of a fusing agent and/or act directly to cool build material. When heating the build material, a detailing agent may thus be applied to reduce a heating effect of a previously applied fusing agent and/or to directly reduce the temperature of the build material. According to examples, a suitable detailing agent may be a formulation commercially known as V1Q61A “HP detailing agent” available from HP Inc. When constructing a 3D object, a detailing agent may be used to form sharp object edges by inhibiting a fusing agent outside of an object boundary and thus preventing solidification in exterior areas of a cross-section, During construction of an object, a detailing agent may also be used to reduce thermal bleed from a solidified area to a non-solidified area and to prevent fusing in certain “blank” or “empty” portions of an object such as internal cavities. At the end of production of an object, unsolidified build material may be removed to reveal the completed object. FIG. 2 shows a particular print head depositing a controlled amount of a printing agent onto an addressable area 214 of the second layer 208-L2 of powdered build material.

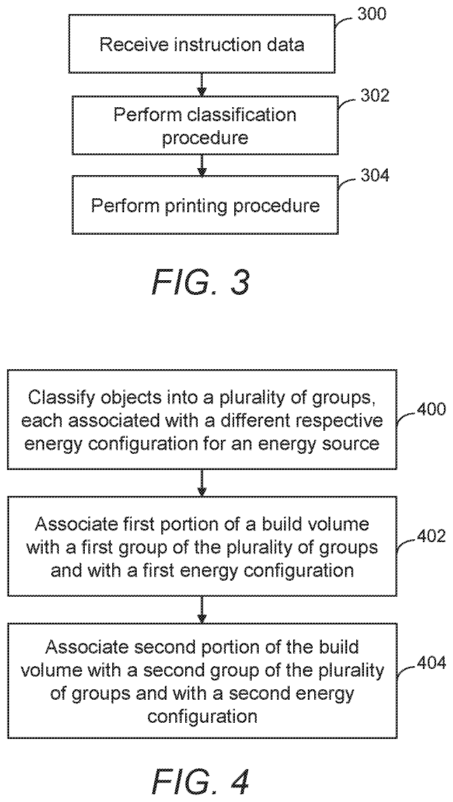

FIG. 3 is a flow diagram showing a method of operating an additive manufacturing system, such as the additive manufacturing systems 100, 200 of FIGS. 1 and 2.

At item 300 of FIG. 3, instruction data is received. The instruction data for example instructs the additive manufacturing system to form a first object and a second object subsequently to the first object. In this way, the first and second objects may be manufactured within the same build process but within separate layers. A single build process such as this may be referred to as a print job.

The instruction data may be generated (and subsequently received by the additive manufacturing system, such as by a control system of the additive manufacturing system) based on a user input. For example, a user may transmit the instruction data to the additive manufacturing system via a computer device operated by the user and coupled to the additive manufacturing system. For example, the user may use a user interface of the computer device to select a plurality of objects to be printed by the additive manufacturing system.

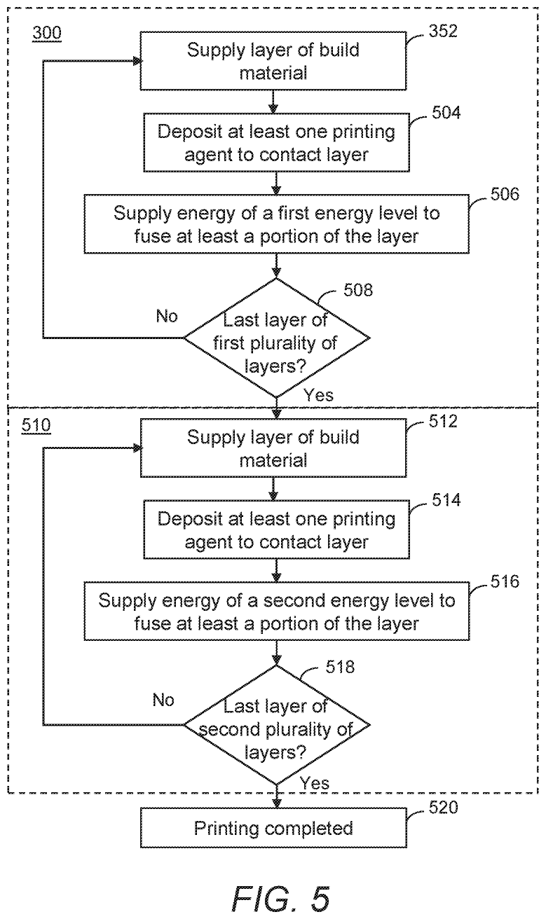

At item 302 of FIG. 3, a classification procedure is performed and at item 304 of FIG. 3, a printing procedure is performed. An example of a classification procedure is illustrated in the flow diagram of FIG. 4 and an example of a printing procedure is shown in the flow diagram of FIG. 5.

Referring to FIG. 4, at item 400, a plurality of three-dimensional objects to be printed by the additive manufacturing system are classified into a plurality of groups. Each of the plurality of groups is associated with a different respective value of an operation parameter associated with the additive manufacturing system. In this example, the operation parameter is an energy configuration of an energy source of the additive manufacturing system. Hence, each group of the plurality of groups are associated with a different respective energy configuration for the energy source (although groups may be associated with respective values of different operation parameters than the energy configuration of the energy source in other examples).

There are variety of ways in which the objects are classified into the plurality of groups. For example, an object may be classified in dependence on any object parameter which is indicative of operational parameters for printing of the object with a desired quality. In this way, objects with similar operational needs, which may be printed using similar values of an operation parameter, may be grouped together.

As the skilled person will appreciate, there are numerous ways to calculate the operational needs for the printing of a particular object. For example, the plurality of objects may be classified in dependence on a shape and/or a size of respective objects. For example, the objects may be classified so that objects within the same group have substantially the same shape or size as each other. Two objects may be considered to be substantially the same shape or size as each other where they are the same in shape or size or broadly similar in shape or size, such as the same shape or size within manufacturing tolerances or with a difference of up to 10% of each other.

The similarity of objects to be printed may be determined by analyzing a shape and/or size of objects to be printed. The dimension of objects to be printed may be calculated and compared with each other so that, for example, objects with a size which differs by less than a predetermined amount may be grouped into the same group. The shape of an object, including its three-dimensional form, may also be analyzed in order to assign the object to an appropriate group for printing. For example, objects which are hollow may be grouped with other hollow objects, such as based on a density of the objects to be printed.

The classification of the objects may be performed using a preconfigured routine, for example based on the receipt of instructions indicative of a plurality of objects to be printed. The classification is for example a spatial organization or spatial arrangement of the objects within a build volume such that objects having the same classification are arranged to be printed in a first set of consecutive layers, and objects having a second classification are arranged to be printed in a second set of consecutive layers (which do not include the first set of layers), For example, prior to performing the method of FIG. 3, a configuration process may have been performed in which a plurality of predefined values for the operation parameter have been determined. The plurality of predefined values may have been identified during a configuration process, Such a configuration process may involve determining a plurality of predefined values for the operation parameter for printing objects of particular shapes, or features, and/or sizes with a desired quality, such as with an acceptable level of defects such as elephant skin or thermal bleed.

In such cases, the shape and/or size of the objects to be printed may be compared with a shape and/or size of a plurality of predefined objects, which were used during the configuration process, and which are each associated with a respective predefined value of the plurality of values. In this way, for each object to be printed, a predefined object of the plurality of objects which is closest in shape and/or size to the object to be printed may be identified. The predefined value associated with the predefined object for objects of each group may be used to print objects of that group.

Alternatively, the objects may be classified based on a user input. For example, a user may indicate that two objects are to be formed within the same group.

The classification of objects into the plurality of groups may be considered to include a three-dimensional nesting process, in which objects of a particular group are arranged in a spatial configuration within the portion of the build volume corresponding to that group to minimize or reduce unfused material within the portion of the build volume. This may involve determining a spatial arrangement of the objects in which the objects are packed or organized in a pattern, to reduce wastage of material and to reduce the time to form the objects. For example, objects may be arranged spatially to reduce unfused build material between neighboring objects, such as in a horizontal direction (e.g. parallel to a build platform) or in a vertical direction (e.g. perpendicular) or both horizontally and vertically.

At item 402 of FIG. 4, a first portion of a build volume of the additive manufacturing system is assigned to a first group of the plurality of groups, and at item 404 of FIG. 4, a second portion of the build volume is assigned to a second group of the plurality of groups. The first portion of the build volume is for example a first vertical portion, such as a first portion in the Z-direction (which is for example a vertical direction or a direction which is perpendicular to a surface of the build platform). The second portion of the build volume may be a second vertical portion, which for example is at a different position in the Z-direction than the first portion of the build volume. The first and second portions of the build volume may therefore be separate regions, which do not share a common volume. Instead, the second portion of the build volume may be on top of the first portion of the build volume, or may at least partly cover the first portion of the build volume. For example, the first portion of the build volume may be located between the build platform and the second portion of the build volume.

The determination of which portion of the build volume to assign to which group of the plurality of groups may depend on the value of the operation parameter associated with each respective group. For example, the groups may be assigned to an appropriate portion of the build volume so that the value of the operation parameter changes sequentially (such as increasing or decreasing sequentially) between different portions of the build volume. In this way, a number of unfused layers of build material (which may be located between two consecutive groups of objects) may be reduced, for example by reducing the length of time for the value of the operation parameter (such as the energy level of the energy source) to reach a desired level, as described further with reference to FIG. 7. Alternatively, each group may be assigned at random to a portion of the build volume or the assignation of groups to respective portions of the build volume may be independent of the value of the operation parameter associated with each group. For example, a group may be assigned to a portion of the build volume based on an initial order of objects to be printed. For example, the first portion of the build volume may include the first object of the plurality of objects to be printed (if the plurality of objects to be printed are ordered in order of time of receipt of instructions of each respective object). The first portion of the build volume may then be used to print other objects which are to be printed with the same value of the operation parameter as the first object (which may be referred to herein as the first value). The second portion of the build volume may then include the first object of the plurality of objects to belong to a different group than the first group (which is printed in the first portion of the build volume). In this way, the second portion of the build volume may then be assigned to a second group (associated with a second value of the operation parameter). This may then continue for other groups. For example, the third portion of the build volume may include the first object of the plurality of objects to belong to a different group than the first and second groups, and may then be used for forming objects of a third group, with a third value of the operation parameter.

FIG. 5 is a flow diagram showing a printing procedure which may be used in conjunction with the examples described herein, such as the method of FIG. 3. The method of FIG. 5 may be performed after a plurality of objects to be printed have been grouped into a plurality of groups, for example as described with reference to FIG. 4.

The method of FIG. 5 includes forming, in a first portion of a build volume, a first object formed of a first plurality of layers of a build material. This is shown schematically in FIG. 5 as the items of the method within the dashed box 500. The first object is formed in this example by supplying, at item 502, a layer of the first plurality of layers to the first portion of the build chamber. At item 504, at least one printing agent is deposited to contact the layer of the first plurality of layers. At item 506, energy of a first level is supplied from an energy source of the additive manufacturing system to the layer of the first plurality of layers to fuse or otherwise solidify at least a portion of the layer of the first plurality of layers. In this example, the operation parameter is an energy level of the energy source. However, in other examples, the operation parameter may be a different parameter, as described later with reference to FIG. 11.

At item 508, it is determined whether the layer at least partially fused at item 506 is the last (or uppermost) layer of the first plurality of layers of the first object. If not, items 502, 504, 506 and 508 are performed again, as part of an iterative procedure, until all the layers of the first plurality of layers of the first object have been deposited and at least partially fused.

Once the first object has been formed, the method of FIG. 5 involves forming, in a second portion of the build volume, a second object formed of a second plurality of layers of the build material subsequent to the first plurality of layers, which is shown schematically as the items of the method within the dashed box 510. In this way, the second object is formed subsequently to the first object, within the same build volume. However, the first and second objects are formed in different respective portions of the build volume. For example, the second object may be formed on top of the first object, such that the first object is between the second object and the build platform, as explained above. In this way, the second object may be formed subsequently to the first object within the same build process. In such cases, the first and second object may be considered to belong to the same build process where they are both formed in response to a single set of instructions (such as the instruction data of FIG. 3) or where the second object is formed on the first object without removing the first object from the build chamber or without cooling the first object.

It is, however, to be appreciated that references to the second object being formed subsequently to the first object are not intended to imply that the second object is necessarily formed immediately consecutively after the first object (with the last layer of the first plurality of layers in contact with the first layer of the second plurality of layers), although it may be. Instead, the second object may be considered to be formed subsequently to the first object if the second object is formed at a later point in time than the first object, with the second plurality of layers deposited, a layer at a time, subsequently to the formation of the first object, regardless of whether there are other components, layers or objects between the first object and the second object.

During a time period between forming the first object and the second object an energy level (which may be referred to as an energy configuration) of the energy source is adjusted. For example, while the energy source supplies energy of the first energy level during the formation of the first object, the energy source may be arranged to supply energy of a second energy level (different from the first energy level) during the formation of the second object. An energy level for example corresponds to an intensity of energy supplied by the energy source. Changing the energy level may change an irradiance received by the build chamber. The irradiance may be considered to be the radiant flux of energy received per unit area of a surface of or within the build chamber (such as a surface of a layer of build material within the build chamber).

For example, methods such as this may involve changing the energy configuration of the energy source in the vertical direction (which may be referred to as the Z-direction) with respect to the build platform 202. For example, the first energy level may be supplied in a first region in the Z-direction and the second energy level may be supplied in a second region in the Z-direction, which is for example above the first region. The first and second regions in the Z-direction may be considered to correspond to the first and second portions of the build volume, respectively.

Other than configuring the energy source with a different energy level than for manufacture of the first object, the second object may be formed similarly to the first object. For example, item 512 of FIG. 5 involves supplying a layer of the second plurality of layers to the build chamber. At item 514, at least one printing agent is deposited to contact the layer of the second plurality of layers. At item 516, energy of the second energy level is applied from the energy source to the layer of the second plurality of layers. At item 518 it is determined whether the layer at least partially fused at item 516 is the last (or uppermost) layer of the second plurality of layers of the second object. If not, items 512, 514, 516 and 518 are performed again, as part of an iterative procedure, until all the layers of the second plurality of layers of the second object have been deposited and at least partially fused.

After the manufacture of the first and second objects 500, 510, the printing process is completed at item 520, However, in other examples, further objects may be printed. It is also to be appreciated that, in FIG. 5, the first object 500 is an object of a first group of objects printed within the first portion of the build volume and the second object 502 is an object of a second group of objects printed within the second portion of the build volume. Hence, although not shown in FIG. 5, printing of the first group of objects may include printing other objects than the first object 500 within the first portion of the build volume, for example also using some or all of the first plurality of layers. Other objects may be formed similarly, for example by depositing at least one printing agent on respective layers of the first plurality of layers in dependence on a shape of the object to be formed, and supplying energy to the respective layers to iteratively fuse portions of respective layers of the first plurality of layers. Similarly, printing of the second group of objects may include printing other objects than the second object 410 within the second portion of the build volume, for example also using some or all of the second plurality of layers.

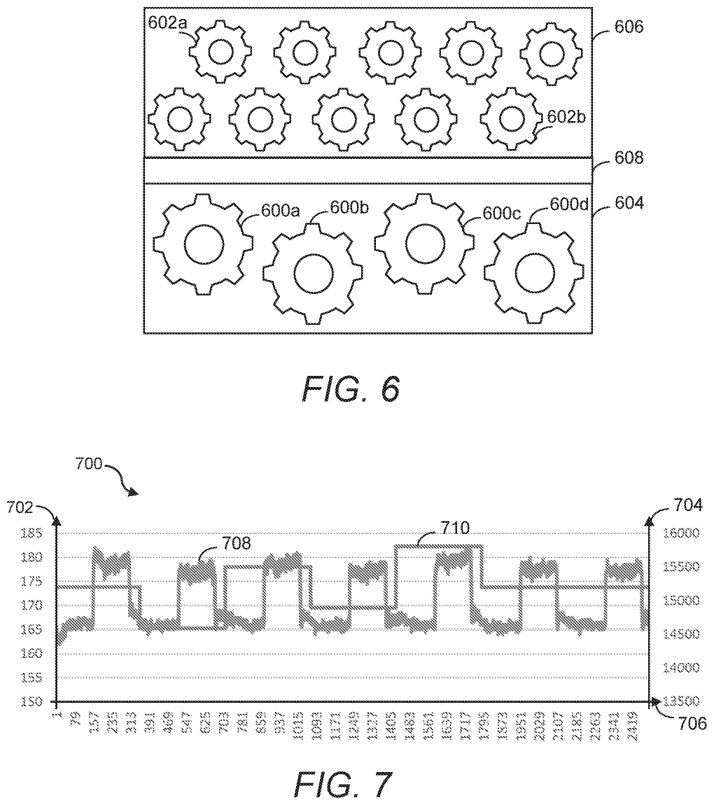

FIG. 6 shows schematically the formation of a first group of objects 600 (labelled 600a, 600b, 600c, 600d) and a second group of objects 602 (two of which are labelled: 602a, 602b). In this example, the first group of objects 600 is formed within a first portion 604 of a build volume and the second group of objects 602 is formed within a second portion 606 of the build volume. In this example, each of the first group of objects 600 has the same structure as each other, and each of the second group of objects 602 has the same structure as each other. Indeed, in FIG. 6, each of the objects has the same shape as each other, although objects of the first group of objects 600 are larger than objects of the second group of objects 602. Hence, in examples such as FIG. 6, methods herein may include forming a plurality of versions of a first object within the first portion 604 of the build volume and forming a plurality of versions of a second object within the second portion 606 of the build volume. Different versions of the same object may have substantially the same configuration. For example, the configuration or physical structure of two versions of the same object may be the same except for minor variations due to differences in manufacturing or system parameters over time or in different locations within the build chamber. This illustrates that the build volume (which is for example the volume within the build chamber) may be stratified into different layers, each associated with a different set of objects,

As will be appreciated, FIG. 6 is merely illustrative. In other examples, the first group of objects 600 may include objects of different shapes and/or sizes than each other. Furthermore, the second group of objects 602 may also or alternatively include objects of different shapes and/or sizes than each other, and objects of the second group of objects 602 may have a different shape but a similar size to objects of the first group of objects 600 or both a different shape and a different size to objects of the first group of objects 600.

In the example of FIG. 6, there is a third plurality of layers 608 of the build material between the first portion 604 of the build volume and the second portion 606 of the build volume. The third plurality of layers 608 for example form a transition region between the first group of objects 600 and the second group of objects 602, allowing these two groups of objects to be separated from each other. The transition region may include any number of layers, In general, the number of layers may depend on the operation parameters for the first and second groups of objects 600, 602, which are separated by the transition region. In an example, the transition region may include 100 to 150 layers of unfused build material.

In such cases, the third plurality of layers 608 of the build material may be supplied to a third portion of the build volume, after forming a first object 600a of the first group of objects 600 and before forming a second object 602a of the second group of objects 602. In examples such as FIG. 6, after forming the first object 600a and the second object 602a, the third plurality of layers 508 is between the first plurality of layers and the second plurality of layers, and hence between the first object 600a and the second object 602a. The third portion of the build volume may therefore be between the first and second portions of the build volume 604, 606. Similarly to the first and second portions of the build volume 604, 606, the third portion of the volume may be a third vertical portion of the build volume, at a different vertical location than the first and second portions of the build volume in the Z-direction.

In examples such as this, an energy level of the energy source may be adjusted from the first energy level to the second energy level during supply of the third plurality of layers 608 to the build chamber, without supplying energy from the energy source to the build chamber. For example, the third plurality of layers 608 may be unfused layers of build material, which are not used for the formation of an object.

The third plurality of layers 608 of the build material may be supplied during a time period over which the energy level (such as the irradiance) of the energy source adjusts to the second energy level. For example, it may not be possible to instantaneously change the energy level of the energy source from the first energy level to the second energy level. Instead, the energy level of the energy source may change gradually.

This may be seen in FIG. 7, which is a graph 700 illustrating the energy configuration of an energy source of an additive manufacturing system and the temperature of a series of objects being manufactured by the additive manufacturing system according to examples. The left-hand y-axis 702 of the graph 700 represents the temperature at the center of an object during printing (in Celsius), the right-hand y-axis 704 of the graph 700 represents the irradiance level in Watts per square centimeter of an energy source (which in this example is a fusing lamp) and the x-axis 706 of the graph 700 represents the number of layers of build material deposited.

The graph 700 illustrates two curves: a temperature curve 708 (which is shown with respect to the temperature axis 702) and an irradiance curve 710 (which is shown with respect to the irradiance level axis 704). The temperature curve 708 of FIG. 7 varies between a relatively high value of around 180 degrees Celsius and a relatively low value of around 165 Celsius. The layers of build material with a relatively low temperature value correspond to layers in which no object has been formed, and the layers of build material with a relatively high temperature value correspond to layers in which an object has been formed. Hence, FIG. 7 illustrates the formation of seven parts (each corresponding to one of the respective high portions of the temperature curve 708). Similarly, the irradiance curve 710 also varies between higher and lower values. Each of the different values of the irradiance curve 710 corresponds to a different respective energy level (or energy configuration) of the energy source. As can be seen, changes between different energy levels for the irradiance curve 710 are slightly out of synchronization with the formation of the objects. In general, the irradiance changes level a few layers after the formation of an object has finished, so that the additive manufacturing system can adapt to the new level of the irradiance (which is for example a new energy level of an energy source) while printing unfused layers, which do not correspond to an object. Finally, after the additive manufacturing system has had sufficient time to adapt to the change in the irradiance level, a new object is formed.

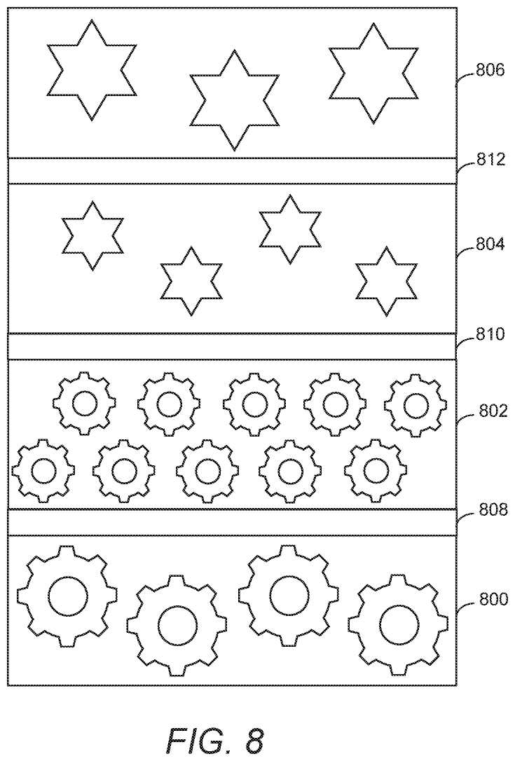

As will be appreciated, the methods described herein may be used to print any number of different groups of object, each of which may be formed using a different respective energy configuration. For example, one group may include small objects, another may include large objects, a yet further group may include solid objects and a still further group may include predominantly hollow objects. FIG. 8 shows an example such as this, in which first, second, third and fourth groups of objects are formed using energy of different respective energy levels supplied from the energy source. The first, second, third and fourth groups of objects are formed in first, second, third and fourth portions 800, 802, 804, 806 of a build volume. There are a plurality of layers 808, 810, 812 between each of the portions 800, 802, 804, 806 of the build volume. As in FIG. 7, the layers 808, 810, 812 are each layers of unfused build material.

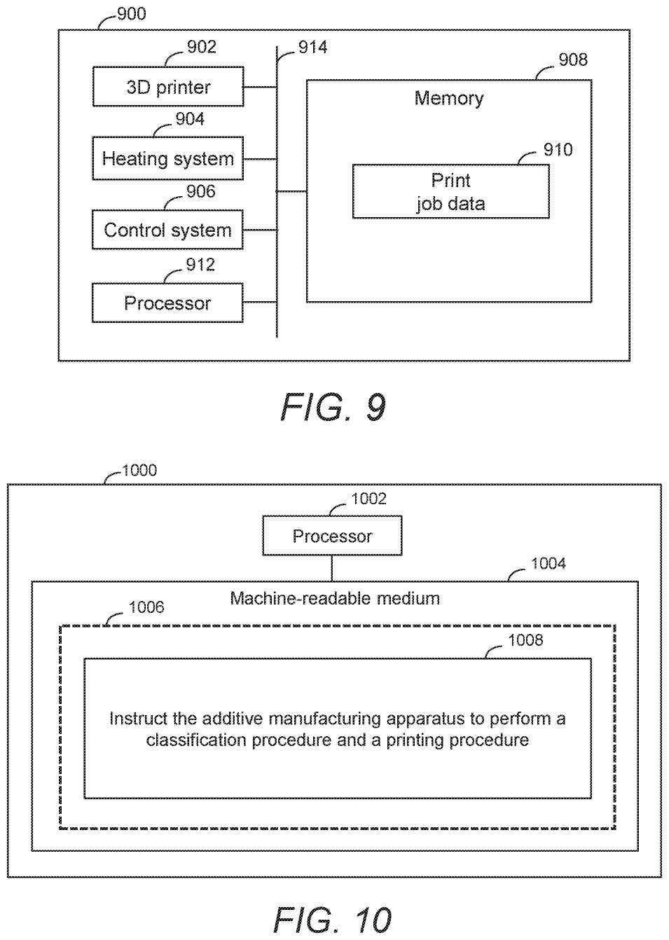

FIG. 9 illustrates schematically a three-dimensional (3D) printing system 900. The 3D printing system 900 of FIG. 9 is similar to the additive manufacturing systems 100, 200 of FIGS. 1 and 2 but with additional components illustrated. The 3D printing system 900 of FIG. 9 includes a 3D printer 902 and a heating system 904, which is an example of an energy source.

The example 3D printing system 900 of FIG. 9 also includes a control system 906. The control system 906 may be arranged to control the 3D printing system 900 in accordance with any of the examples described herein. For example, the control system 906 may be arranged to receive print job data representative of a print job including printing a plurality of objects. The control system 906 may also be arranged to process the print job data to classify the plurality of objects into a plurality of groups, each associated with a different respective value of a heat setting for the heating system and a different respective portion of a build chamber of the 3D printing system 900. The heat setting for example represents a thermal irradiance supplied by the heating system 904 to a build region of the 3D printer system 900, such as a thermal irradiance of a heat source of the heating system 904. The control system 906 may be arranged control the 3D printer 902 to print the print job by configuring the heating system 904 with a first value of the heat setting and, with the heating system configured with the first value of the heat setting, controlling the 3D printer 902 to form, a first portion of the build chamber, a first object of the first group. Forming of the first object may include supplying a first plurality of layers, for example of a build material, to the first portion of the build chamber, and selectively solidifying at least a portion of the first plurality of layers using thermal energy supplied from the heating system 904. The print job may further include subsequently configuring the heating system 904 with the second value of the heat setting and, with the heating system 904 configured with the second value of the heat setting, forming, in a second portion of the build chamber, a second object of the second group. Forming of the second object may include supplying a second plurality of layers, for example of a build material, to the second portion of the build chamber, and selectively solidifying at least a portion of the second plurality of layers using thermal energy supplied from the heating system 904. In this way, the control system 906 may be arranged to implement any of the methods described herein.

For example, the control system 906 may also be arranged to control the 3D printer 902 to supply a plurality of unfused layers of a build material to the build chamber, after the forming the first object and before the forming the second object, such that, after the forming the first object and the second object, the plurality of unfused layers separates the first object from the second object.

The control system 906 may receive data from a memory 908. The memory 908 may include at least one of volatile memory, such as a random access memory (RAM) and non-volatile memory, such as read-only memory (ROM) or a solid state drive (SSD) such as Flash memory. The memory 908 in examples may include further storage devices, for example magnetic, optical or tape media, compact disc (CD), digital versatile disc (DVD) or other data storage media. The memory 908 may be removable or non-removable from the 3D printing system 900. The 3D printer 902 may include the memory 908.

In the example of FIG. 9, the memory 908 includes print job data 910, described above. The control system 906 may use the data of the memory 908 to control the operation of the 3D printing system 900, for example to implement processes such as those described herein.

In the example of FIG. 9, the 3D printing system 900 further includes a processor 912, which is communicatively coupled to the memory 908. The processor 912 in FIG. 9 may be a microprocessor, a general purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration. The components of the 3D printing system 900 in the example of FIG. 9 are interconnected using a systems bus 914. This allows data to be transferred between the various components.

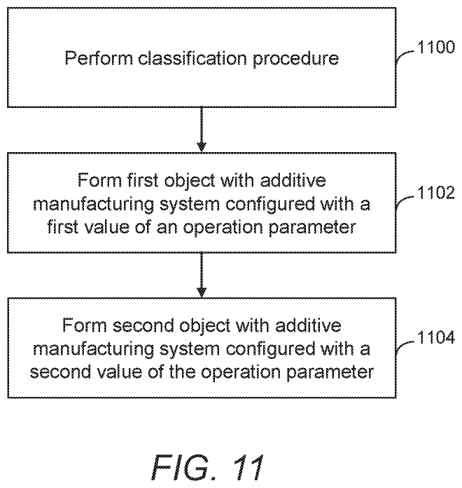

Certain system components and methods described herein may be implemented by way of machine-readable instructions that are storable on a non-transitory storage medium. FIG. 10 shows an example of an additive manufacturing apparatus 1000 including at least one processor 1002 arranged to retrieve data from a machine-readable medium 1004, which may be referred to as a computer-readable storage medium. The machine-readable medium 1004 includes a set of computer-readable instructions 1006 stored thereon. The at least one processor 1002 is configured to load the instructions 1006 into memory for processing. The instructions 1006 are arranged to cause the at east one processor 1002 to perform a series of actions.

Instruction 1008 is configured to cause the processor 1002 to instruct the additive manufacturing apparatus 1000 to perform a classification procedure, such as the classification procedure described with reference to FIGS. 3 and 4, and a printing procedure, such as that described with reference to FIGS. 3 and 5 to 8. For example, the printing procedure may include printing a first object of the first group within a first vertical portion of the build volume by depositing a first portion of a build material within the first vertical portion of the build volume and selectively fusing at least part of the first portion of the build material using an energy source of the additive manufacturing apparatus 1000 configured with a first energy configuration, the first energy configuration being the energy configuration associated with the first group. The printing procedure may further include printing a second object of the second group within a second vertical portion of the build volume by depositing a second portion of the build material within the second vertical portion of the build volume and selectively fusing at least part of the second portion of the build material using the energy source configured with a second energy configuration, the second energy configuration being the energy configuration associated with the second group.

The non-transitory machine-readable medium 1008 can be any medium that can contain, store, or maintain programs and data for use by or in connection with an instruction execution system. Machine-readable media can include any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

The preceding description has been presented to illustrate and describe examples of the principles described. This description is not intended to be exhaustive or to limit these principles to any precise form disclosed. Many modifications and variations are possible in light of the above teaching. For example, although examples described above involve applying one or more printing agent to a layer of build material and selectively fusing at least a portion of the layer of the build material according to the pattern of the one or more printing agent, other examples are envisaged. For example, the methods described herein may be applied in other additive manufacturing systems or processes than those described herein, such as other additive manufacturing systems involving the selective application of energy, such as thermal energy, to form objects. For example, the methods described herein may be used with selective laser sintering systems, in which a laser may be used to selectively solidify portions of a build material without application of a printing agent.

Further examples are envisaged. In the above-described examples. different groups of objects are formed using different values of an energy configuration, energy level or heat setting of an energy source (such as a heating system). However, in other examples, different groups of objects may be printed using different values of a different operation parameter of an additive manufacturing system than the energy configuration, energy level or heat setting.

FIG. 11 is a flow diagram illustrating schematically an example of operating an additive manufacturing system. It is to be appreciated that methods such as that of FIG. 11 may be otherwise the same as or similar to the other examples described above, with the exception that the value of the operation parameter is altered between printing of various different groups of objects rather than altering an energy configuration or energy level of an energy source of the additive manufacturing system. Indeed, an energy configuration or energy level of an energy source may be considered to be an example of an operation parameter.

The method of FIG. 11 includes, at item 1100, performing a classification procedure. The classification procedure is for example similar to the classification procedure of FIG. 4, except that objects are classified into a plurality of groups, each associated with a different respective value of an operation parameter, rather than a different respective configuration for an energy source. An operation parameter is for example any variable or component of the additive manufacturing system that may be altered to alter a structure of an object formed by the additive manufacturing system. Such variables may therefore be adjusted to obtain a desired quality of an object printed by the additive manufacturing system. Examples of operation parameters include a density of one or more printing agents to be applied to a layer of build material or a laser power of a laser to be applied to a layer of build material to selectively fuse the layer of build material (for example in a selective laser sintering additive manufacturing system).

At item 1102, the additive manufacturing system is configured with a first value of the operation parameter, where the first value of the operation parameter is associated with a first group of the plurality of groups. With the additive manufacturing system configured with the first value of the operation parameter, the additive manufacturing system is used to form, within the first portion of the build volume, a first object of the first group. The first object may be formed of a first plurality of layers of a build material and may be formed as explained above, for example by iteratively supplying layers of the first plurality of layers and selectively solidifying each layer in turn (for example by applying at least one printing agent to contact each layer and then applying thermal energy to the layer).

At item 1104 of FIG. 12, a second object is formed with the additive manufacturing system configured with a second value of the operation parameter, where the second value is different from the first value for example. For example, where the operation parameter is a density of a printing agent, the forming of the first object at item 1102 may involve depositing a first density, depth or composition of the printing agent per layer of the first plurality of layers, and the forming of the second object at item 1104 may involve depositing a second density, depth or composition of the printing agent per layer of the second plurality of layers.

As explained above with reference to other examples, the first and second objects may be formed as part of the same build process. The method of FIG. 11 may further include depositing a third plurality of layers between the first and second objects, for example while the operation parameter is adjusted from the first value to the second value. As for the other examples above, the method of FIG. 11 may also include forming additional objects within the same build process, such as at least one further object with a different shape to the shape of the first and second objects. Alternatively, the first and second objects may be different versions of the same object and the method of FIG. 11 may further include forming at least one version of a different object. Furthermore, the forming of the first object may be performed as part of the forming of a plurality of objects of the first group of objects, and the forming of the second object may be performed as part of the forming of a plurality of objects of the second group of objects.

It is to be appreciated that methods and systems in accordance with FIG. 11 may be used with a variety of different additive manufacturing systems, including those that involve the selective application of energy or the selective application of chemical binders. For example, methods and systems in accordance with FIG. 11 may be used in Binder Jetting or metal type 3D printing. In such cases, the operation parameter may be a density of a chemical binder to be applied to a build material, for example.

In examples described above, there are a plurality of layers of unfused build material between consecutive groups of objects, each printed using a different respective value of an operation parameter, such as a different energy level of an energy source of the additive manufacturing system. However, in some cases, there may be no unfused build material between at least some such consecutive groups of groups.

In examples described above, a classification procedure is performed by an additive manufacturing system. However, in other examples, a classification procedure such as those described above may be performed by other systems or apparatus. For example, such classification procedures may be performed externally to the additive manufacturing system, for example in a pre-processing application. Instructions on the basis of the classification procedure, for example to instruct a printing procedure such as that described above, may then be sent to the additive manufacturing system, for the additive manufacturing system to print the objects classified according to the classification procedure.

It is to be understood that any feature described in relation to any one example may be used alone, or in combination with other features described, and may also be used in combination with any features of any other of the examples, or any combination of any other of the examples.

What is claimed is:

1. A method of operating an additive manufacturing system, the method comprising:
classifying a plurality of three-dimensional objects to be formed by the additive manufacturing system into a plurality of groups, each of the plurality of groups associated with a different respective value of an operation parameter associated with the additive manufacturing system;
assigning a first portion of a build volume of the additive manufacturing system to a first group of the plurality of groups;
assigning a second portion of the build volume, different from the first portion of the build volume, to a second group of the plurality of groups;
configuring the additive manufacturing system with a first value of the operation parameter, the first value of the operation parameter being the value associated with the first group;
with the additive manufacturing system configured with the first value of the operation parameter, using the additive manufacturing system to form, within the first portion of the build volume, a first object of the first group, the first object formed of a first plurality of layers of a build material;
subsequently configuring the additive manufacturing system with a second value of the operation parameter, the second value of the operation parameter being the value associated with the second group; and
with the additive manufacturing system configured with the second value of the operation parameter, using the additive manufacturing system to form, within the second portion of the build volume, a second object of the second group, the second object formed of a second plurality of layers of the build material subsequent to the first plurality of layers.

2. The method according to claim 1, wherein the classifying the plurality of three-dimensional objects comprises classifying the plurality of three-dimensional objects in dependence on a shape and/or a size of respective objects or features of the plurality of three-dimensional objects.

3. The method according to claim 1, wherein the classifying the plurality of three-dimensional objects comprises classifying the plurality of three-dimensional objects such that objects within the same group of the plurality of groups have substantially the same shape or size as each other.

4. The method according to claim 1, wherein the additive manufacturing system comprises an energy source and the operation parameter is an energy level of the energy source.

5. The method according to claim 1, wherein:
the assigning the first portion of the build volume to the first group comprises selecting the first value from a plurality of predefined values for the operation parameter, as the value associated with the first group; and
the assigning the second portion of the build volume to the second group comprises selecting the second value from the plurality of predefined values for the operation parameter, as the value associated with the second group.

6. The method according to claim 1, comprising forming a plurality of versions of the first object within the first portion of the build volume and forming a plurality of versions of the second object within the second portion of the build volume.

7. The method according to claim 1, wherein the first portion of the build volume is between a build platform of the additive manufacturing system and the second portion of the build volume.

8. The method according to claim 1, wherein the forming the second object comprises forming the second object subsequently to the first object within the same build process.

9. The method according to claim 1, comprising, before the forming the first object and the second object, receiving instruction data to instruct the additive manufacturing system to form the first object and to form the second object subsequently to the first object.

10. The method according to claim 1, comprising supplying a third plurality of layers of the build material to a third portion of the build volume, after the forming the first object and before the forming the second object, wherein the third portion of the build volume is between the first portion of the build volume and the second portion of the build volume.

11. The method according to claim 10, wherein the additive manufacturing system comprises an energy source, the operation parameter is an energy level of the energy source, the first value corresponds to a first energy level, the second value corresponds to a second energy level, and the method comprises adjusting the energy level of the energy source from the first energy level to the second energy level during the supplying the third plurality of layers, without supplying energy from the energy source to the build volume.

12. A three-dimensional (3D) printing system comprising:
a 3D printer comprising a heating system; and
a control system arranged to:
receive print job data representative of a print job comprising printing a plurality of objects;
process the print job data to spatially arrange the plurality of objects into a plurality of groups, each of the plurality of groups associated with a different respective value of a heat setting for the heating system and a different respective portion of a build chamber of the 3D printing system; and
control the 3D printer to print the print job, by:
configuring the heating system with a first value of the heat setting;
with the heating system configured with the first value of the heat setting, controlling the 3D printer to form, in a first portion of the build chamber, a first object of the first group by controlling the 3D printer to:
supply a first plurality of layers to the first portion of the build chamber; and
selectively solidify at least a portion of the first plurality of layers using thermal energy supplied from the heating system;
subsequently configuring the heating system with the second value of the heat setting; and
with the heating system configured with the second value of the heat setting, controlling the 3D printer to form, in a second portion of the build chamber, a second object of the second group by controlling the 3D printer to:
supply a second plurality of layers to the second portion of the build chamber; and
selectively solidify at least a portion of the second plurality of layers using thermal energy supplied from the heating system.

13. The 3D printing system according to claim 12, wherein the control system is arranged to control the 3D printer to supply a plurality of unfused layers of a build material to the build chamber, after the forming the first object and before the forming the second object, such that, after the forming the first object and the second object, the plurality of unfused layers separates the first object from the second object.

14. The 3D printing system according to claim 12, wherein the heat setting represents a thermal irradiance of a heat source of the heating system.

15. A non-transitory machine-readable medium comprising instructions which, when executed by a processor of an additive manufacturing apparatus comprising an energy source, cause the processor to instruct the additive manufacturing apparatus to perform a routine comprising:
a classification procedure comprising:
classifying a plurality of three-dimensional objects to be printed by the additive manufacturing system into a plurality of groups, each of the plurality of groups associated with a different respective energy configuration for the energy source;
assigning a first vertical portion of a build volume of the additive manufacturing system to a first group of the plurality of groups; and
assigning a second vertical portion of the build volume to a second group of the plurality of groups; and
a printing procedure comprising:
printing a first object of the first group within the first vertical portion of the build volume by depositing a first portion of a build material within the first vertical portion of the build volume and selectively fusing at least part of the first portion of the build material using the energy source configured with the first energy configuration, the first energy configuration being the energy configuration associated with the first group; and
printing a second object of the second group within the second vertical portion of the build volume by depositing a second portion of the build material within the second vertical portion of the build volume and selectively fusing at least part of the second portion of the build material using the energy source configured with the second energy configuration, the second energy configuration being the energy configuration associated with the second group.
